(19) United States
(12) Patent Application Publication
(10) Pub. No.: US 2025/0313744 A1
(43) Pub. Date: Oct. 9, 2025

(54) SLURRIES INCLUDING EPOXY RESINS

(71) Applicant: Saudi Arabian Oil Company, Dhahran (SA)

(72) Inventors: Nada M. Bokhamsin, Dammam (SA); Abdullah Saleh Hussain Al-Yami, Dhahran (SA); Ali Al-Safran, Dhahran (SA); Vikrant Wagle, Abqaiq (SA); Ahmed Nabil Al-Dughaither, Al Khobar (SA); Nasser S. Alalhareth, Ras Tanura (SA)

(21) Appl. No.: 18/630,520

(22) Filed: Apr. 9, 2024

(51) Int. Cl. C09K 8/508; C08G 59/18; C08K 3/36; E21B 33/14

(52) U.S. Cl. CPC C09K 8/5086; C08G 59/184; C08K 3/36; E21B 33/14

(57) ABSTRACT

The present disclosure relates to slurries including an epoxy resin, a curing agent, silica sand, and silica flour, and to methods of sealing an annulus of a wellbore therewith.

### TECHNICAL FIELD

The present disclosure relates to slurries including an epoxy resin, a curing agent, silica sand, and silica flour.

### BACKGROUND

Primary sealing of a wellbore involves the process of initially sealing the annulus upon installation of the casing or other tubular string. Primary sealing may refer to initial sealing of the annulus between the exterior surface of the tubular string and the wellbore wall of the wellbore, or initial sealing of a casing-casing annulus. Primary sealing forms a protective solid sheath around the exterior surface of the tubular string.

Primary sealing in conventional wellbore installations may be performed with wellbore cement and, thus, may be commonly referred to as “primary cementing.” During hydrocarbon production, the cement sheath may be subjected to temperature and pressure cycling. This temperature and pressure cycling may cause micro-cracks to form in the cement sheath. Fluids, such as gas or liquids, may then migrate through the micro-cracks, which may cause pressure buildup in the annuli, referred to as casing-casing annulus pressure. Increasing casing-casing annulus pressure caused by micro-cracks in the cement sheath may cause damage to interior structures of the well, such as interior casings and production liners. Greater casing-casing annulus pressure may also cause fluids to migrate through the cement sheath to the surface, where the fluids may be released to the environment. This effect is particularly relevant to wellbores with a gas cap in shallow zones. If the cement sheath is not adequately bonded to the casing, gas can enter the wellbore and potentially reach the surface.

Therefore, there is a need for improved compositions for sealing a wellbore that provide improved bonding strength, for example between a casing string and slurry column.

### SUMMARY

The present disclosure provides a slurry including about 20 wt % to about 60 wt % of an epoxy resin, about 0.01 wt % to about 5 wt % of a curing agent, about 20 wt % to about 60 wt % silica sand; and about 1 wt % to about 40 wt % silica flour.

The present disclosure also provides a method of sealing a wellbore, including injecting a slurry of the present disclosure into an annulus of the wellbore, and curing the slurry to form a cured composition, thereby sealing the annulus.

### BRIEF DESCRIPTION OF DRAWINGS

FIG. 1 is a process flow diagram of a method for sealing a wellbore.

FIG. 2 is a representative plot showing a thickening time test result.

FIG. 3 is a plot showing a thickening time test result for a slurry according to certain embodiments of the present disclosure.

FIG. 4 is a plot showing a thickening time test result for a slurry according to certain embodiments of the present disclosure.

FIG. 5 is a plot showing a thickening time test result for a slurry according to certain embodiments of the present disclosure.

### DETAILED DESCRIPTION

The present disclosure relates to slurries including an epoxy resin, a curing agent, silica sand, and silica flour. In some embodiments, the slurries are substantially free from cement. Such slurries can be useful in primary sealing applications, such as sealing of a casing-casing annulus (CCA) of a wellbore. In some embodiments, the slurries have rheological properties and curing times suitable for pumping, and, upon curing, have high compressive strengths. The slurries of the present disclosure can provide improved bonding strength between a casing string and slurry column of a wellbore as compared to conventional, cement-containing compositions. Accordingly, upon curing, such slurries can provide an effective annulus seal, and help to mitigate or even prevent CCA leaks.

### Slurries

Provided in the present disclosure are slurries including about 20 wt % to about 60 wt % of an epoxy resin, about 0.01 wt % to about 5 wt % of a curing agent, about 20 wt % to about 60 wt % silica sand, and about 1 wt % to about 40 wt % silica flour. In some embodiments, the slurry includes less than 5 wt % of cement, for example, less than 4 wt %, less than 3 wt %, less than 2.5 wt %, less than 2 wt %, less than 1 wt %, or less than 0.5 wt % of cement. In some embodiments, the slurry is substantially free from cement.

In some embodiments, the epoxy resin includes bisphenol-A-based epoxy resins, bisphenol-F-based epoxy resins, aliphatic epoxy resins, or any combination thereof. In some embodiments, the epoxy resin includes a bisphenol-A-based epoxy resin. In certain such embodiments, the epoxy resin includes a bisphenol-A-epichlorohydrin epoxy resin.

In some embodiments, the epoxy resin includes a glycidyl ether. In some embodiments, the glycidyl ether includes an n-butyl glycidyl ether, a phenyl glycidyl ether, a p-tertiary butyl phenyl glycidyl ether, a C₈-C₁₄ alkyl glycidyl ether, a cresyl glycidyl ether, a 2-ethylhexyl glycidyl ether, a p-cumenol glycidyl ether, a glycidyl ether of neodecanoic acid, a diglycidyl ether of cyclohexane, a diglycidyl ether of resorcinol, a diglycidyl ether of bisphenol A, a diglycidyl ether of bisphenol F, a diglycidyl ether of 2-methyl resorcinol, a diglycidyl ether of 1,4-butanediol, a diglycidyl ether of neopentyl glycol, a diglycidyl ether of 2,2,-di(1,4-cyclohexyl)propane, a triglycidyl ether of glycerol, or any combination thereof. In some embodiments, the epoxy resin includes an aliphatic glycidyl ether. In some embodiments, the epoxy resin includes a C₈-C₁₄ alkyl glycidyl ether, for example, a C₁₂-C₁₄ alkyl glycidyl ether.

In some embodiments, the epoxy resin includes a bisphenol-A-epichlorohydrin epoxy resin and a C₁₂-C₁₄ alkyl glycidyl ether. In certain such embodiments, a weight ratio of a total amount of bisphenol-A-epichlorohydrin epoxy resin and C₁₂-C₁₄ alkyl glycidyl ether present in the slurry is about 6:1 to about 1:1, for example, about 6:1 to about 2:1, about 6:1 to about 3:1, about 5:1 to about 1:1, about 5:1 to about 2:1, about 5:1 to about 3:1, about 4:1 to about 1:1, about 4:1 to about 2:1, about 4:1 to about 3:1, or about 3:1 to about 1:1.

In some embodiments, the slurry includes about 20 wt % to about 55 wt %, about 20 wt % to about 50 wt %, about 30 wt % to about 60 wt %, about 30 wt % to about 55 wt %, about 30 wt % to about 50 wt %, about 35 wt % to about 60 wt %, about 35 wt % to about 55 wt %, or about 35 wt % to about 50 wt % of the epoxy resin. In some embodiments, the slurry includes about 30 wt %, about 35 wt %, about 40 wt %, about 45 wt %, or about 50 wt % of the epoxy resin.

In some embodiments, the average molecular weight of the epoxy resin is about 300 g/mol to about 2,000 g/mol. In some embodiments, the epoxy resin has an epoxy value of from 4.5 epoxy equivalents per kilogram of the epoxy resin to 5.5 epoxy equivalents per kilogram of the epoxy resin. In some embodiments, the epoxy resin has an epoxy equivalent weight of from 170 to 350 grams of resin per epoxy equivalent (g/eq).

In some embodiments, the curing agent includes an amine, a polyamine, an amine adduct, a polyamine adduct, an alkanolamine, an amide, a polyamide, a polyamide adduct, a polyamide imidazoline, a polyaminoamide, a phenalkamine, or any combination thereof. In some embodiments, the amine or polyamine curing agent includes an aromatic amine, an aliphatic amine, a cycloaliphatic amine, a modified cycloaliphatic amine such as a cycloaliphatic amine modified by polyacrylic acid, an aliphatic polyamine, a cycloaliphatic polyamine, a modified polyamine such as a polyamine modified by polyacrylic acid, or an amine adduct such as a cycloaliphatic amine adduct, or a polyamine adduct.

In some embodiments, the curing agent includes diethanolamine, ethanolamine, butylamine, 2-amino-methyl-(2-propanol) amine, 2-butyl-aminoethanol, N-methyl ethanolamine, 2-methyl isopropanol amine, 2,2-ethoxy ethanolamine, methyl ethanolamine, benzy ethanolamine, tetrabutyl amine, diethylamine, dipropylamine, aniline, benzylamine, 4-hydroxy benzylamine, cyclohexane diamine, ethylenediamine, isophorone diamine, N-β-hydroxy ethyl ethylene diamine, m-xylylene diamine, dibutylamine, or any combination thereof.

In some embodiments, the curing agent includes trimethyl hexamethylene diamine (TMD), diethylenetriamine (DETA), triethylenetetramine (TETA), meta-xylenediamine (MXDA), aminoethylpiperazine (AEP), tetraethylenepentamine (TEPA), polyetheramine, isophoronediamine (IPDA), beta-hydroxyalkyl amide (HAA), or any combination thereof. In some embodiments, the curing agent includes DETA, TETA, TEPA, IPDA, or any combination thereof. In some embodiments, the curing agent includes TEPA.

In some embodiments, the slurry includes about 0.01 wt % to about 4 wt %, about 0.01 wt % to about 3 wt %, about 0.1 wt % to about 5 wt %, about 0.1 wt % to about 4 wt %, about 0.1 wt % to about 3 wt %, about 0.5 wt % to about 5 wt %, about 0.5 wt % to about 4 wt %, or about 0.5 wt % to about 3 wt % of the curing agent. In some embodiments, the slurry includes about 0.5 wt %, about 0.75 wt %, about 1 wt %, about 1.25 wt %, about 1.5 wt %, about 1.75 wt %, about 2 wt %, about 2.25 wt %, or about 2.5 wt % of the curing agent.

The silica sand can include any naturally occurring or man-made silica sand. In some embodiments, an average particle size of the silica sand is about 75 μm to about 250 μm, about 75 μm to about 200 μm, about 75 μm to about 175 μm, about 100 μm to about 250 μm, about 100 μm to about 200 μm, about 100 μm to about 175 μm, about 125 μm to about 250 μm, about 125 μm to about 200 μm, or about 125 μm to about 175 μm. In some embodiments, an average particle size of the silica sand is about 100 μm, about 125 μm, about 150 μm, or about 175 μm.

In some embodiments, the slurry includes about 20 wt % to about 55 wt %, about 20 wt % to about 50 wt %, about 25 wt % to about 60 wt %, about 25 wt % to about 55 wt %, about 25 wt % to about 50 wt %, about 30 wt % to about 60 wt %, about 30 wt % to about 55 wt %, or about 30 wt % to about 50 wt % silica sand. In some embodiments, the slurry includes about 30 wt %, about 35 wt %, about 40 wt %, about 45 wt %, or about 50 wt % silica sand.

The silica flour can include any naturally occurring or man-made silica flour. The silica flour has an average particle size that is less than an average particle size of the silica sand. In some embodiments, an average particle size of the silica flour is about 5 μm to about 75 μm, about 5 μm to about 60 μm, about 5 μm to about 55 μm, about 15 μm to about 75 μm, about 15 μm to about 60 μm, about 15 μm to about 55 μm, about 25 μm to about 75 μm, about 25 μm to about 60 μm, or about 25 μm to about 55 μm. In some embodiments, an average particle size of the silica sand is about 25 μm, about 30 μm, about 35 μm, about 40 μm, about 45 μm, about 50 μm, or about 55 μm.

In some embodiments, the slurry includes about 1 wt % to about 30 wt %, about 1 wt % to about 25 wt %, about 7 wt % to about 40 wt %, about 7 wt % to about 30 wt %, about 7 wt % to about 25 wt %, about 10 wt % to about 40 wt %, about 10 wt % to about 30 wt %, or about 10 wt % to about 25 wt % silica flour. In some embodiments, the slurry includes about 7 wt %, about 10 wt %, about 15 wt %, about 20 wt %, or about 25 wt % silica flour.

In some embodiments, a weight ratio of silica sand to silica flour present in the slurry is about 5:1 to about 1:1, for example, about 5:1 to about 1.5:1, about 4:1 to about 1:1, about 4:1 to about 1.5:1, about 3:1 to about 1:1, about 3:1 to about 1.5:1, about 2.5:1 to about 1:1, or about 2.5:1 to about 1.5:1. In some embodiments, a weight ratio of silica sand to silica flour present in the slurry is about 3:1, about 2.5:1, about 2:1, or about 1:5:1.

In some embodiments, the silica sand and silica flour are present in a combined amount of at least about 40 wt % of the slurry. For example, in some embodiments, the silica sand and silica flour are present in a combined amount of about 40 wt % to about 75 wt %, about 40 wt % to about 70 wt %, about 40 wt % to about 65 wt %, about 45 wt % to about 75 wt %, about 45 wt % to about 70 wt %, about 45 wt % to about 65 wt %, about 50 wt % to about 75 wt %, about 50 wt % to about 70 wt %, or about 50 wt % to about 65 wt %. In some embodiments, the silica sand and silica flour are present in a combined about of about 45 wt %, about 50 wt %, about 55 wt %, about 60 wt %, about 65 wt %, or about 70 wt % of the slurry.

### Sealing Methods

Also provided in the present disclosure is a method for sealing a wellbore. The method includes injecting a slurry including an epoxy resin, a curing agent, silica sand, and silica flour into an annulus of the wellbore, and curing the slurry to form a cured composition, thereby sealing in the annulus. In some embodiments, the slurry is any slurry of the present disclosure. In some embodiments, injecting the slurry includes pumping the slurry into an annulus between the wellbore and a casing in the wellbore. In some embodiments, injecting the slurry includes pumping the slurry into an annulus between a first casing and a second casing in the wellbore, for example, between a casing string and slurry column of the wellbore.

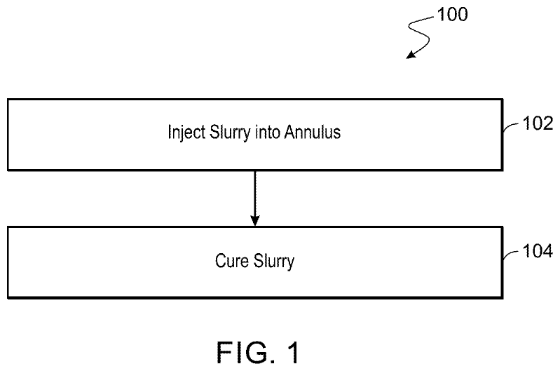

FIG. 1 is a process flow diagram of a method 100 for sealing a wellbore. The method starts at block 102 with the injecting of a slurry of the present disclosure into an annulus of the wellbore. At block 104 of the method, the slurry is cured.

### Definitions

The terms “a,” “an,” and “the” are used in the present disclosure to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in the present disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used in the present disclosure, the term “about” can allow for a degree of variability in a value or range, for example, within 10%, within 5%, or within 1% of a stated value or of a stated limit of a range.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used in the present disclosure, the “epoxy equivalent weight” of an epoxy resin is the weight of the epoxy resin in grams that contains one equivalent weight of epoxy. The epoxy equivalent weight of the epoxy resin is equal to the molecular weight of the epoxy resin divided by the average number of epoxy groups in the epoxy resin.

As used in the present disclosure, the term “curing” refers to achieving desired properties of a settable composition (such as hardness) through one or more reactions between the components of the composition. As used in the present disclosure, in reference to an epoxy resin-containing composition, a “curing agent” can also be referred to as a “cross-linking agent.”

As used in the present disclosure, the term “thickening time” refers to the time during which a cement composition remains in a fluid state and is capable of being pumped, for example, up to about 100 Bc. Thickening time can be determined, for example, at about 120° C. and about 2,700 psi. Unless otherwise specified, thickening time values in the present disclosure are measured according to American Petroleum Institute (API) Recommended Practice 10B-2.

The term “downhole,” as used in the present disclosure, can refer to under the surface of the earth, such as a location within or fluidly connected to a wellbore.

As used in the present disclosure, the term “subterranean formation” can refer to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region that is in fluid contact with the wellbore. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground that is in fluid contact with liquid or gaseous petroleum materials or water. In some embodiments, a subterranean formation is an oil well.

As used in the present disclosure, the term “wellbore” refers to a hole that extends from the surface to a location beneath the surface to permit access to hydrocarbon-bearing subterranean formations. The wellbore contains at least a portion of a fluid conduit that links the interior of the wellbore to the surface. The fluid conduit coupling the interior of the wellbore to the surface may be capable of permitting regulated fluid flow from the interior of the wellbore to the surface. The fluid conduit may also permit access between equipment on the surface and the interior of the wellbore. The fluid conduit may be defined by one or more tubular strings, such as casings for example, inserted into the wellbore and secured in the wellbore.

### EXAMPLES

### Example 1. Slurry Preparation and Characterization

Slurries 1-3, having the compositions shown in Tables 1-3, were prepared using a standard API blender, a propeller-type mixing device. The maximum rotational speed used during slurry preparation was 12,000 rotations per minute (RPM).

TABLE 1
Slurry 1 Formulation

| Component | Quantity (g) |
|---|---|
| Epoxy Resin 1^{†} | 400 |
| Epoxy Resin 2^{‡} | 100 |
| Silica Flour | 203.75 |
| Silica Sand | 475.5 |
| TEPA | 17 |

^{†}Mixture of low-viscosity epoxy resin including a bisphenol-A-epichlorohydrin epoxy resin and a C₁₂-C₁₄ alkyl glycidyl ether
^{‡}C₁₂-C₁₄ alkyl glycidyl ether

TABLE 2
Slurry 2 Formulation

| Component | Quantity (g) |
|---|---|
| Epoxy Resin 1^{†} | 400 |
| Epoxy Resin 2^{‡} | 100 |
| Silica Flour | 203.75 |
| Silica Sand | 475.5 |
| TEPA | 22.5 |

^{†}Mixture of low-viscosity epoxy resin including a bisphenol-A-epichlorohydrin epoxy resin and a C₁₂-C₁₄ alkyl glycidyl ether
^{‡}C₁₂-C₁₄ alkyl glycidyl ether

TABLE 3
Slurry 3 Formulation

| Component | Quantity (g) |
|---|---|
| Epoxy Resin 1^{†} | 400 |
| Epoxy Resin 2^{‡} | 100 |
| Silica Flour | 203.75 |
| Silica Sand | 475.5 |
| TEPA | 23.75 |

^{†}Mixture of low-viscosity epoxy resin including a bisphenol-A-epichlorohydrin epoxy resin and a C₁₂-C₁₄ alkyl glycidyl ether
^{‡}C₁₂-C₁₄ alkyl glycidyl ether

### Slurry Rheology

The slurry was conditioned in an atmospheric consistometer before obtaining rheological readings. A Fann viscometer (Model-35), a rotational cylinder and bob instrument having two speeds of rotation (300 and 600 rpm) was used to evaluate the slurry rheology.

### Thickening Time Testing

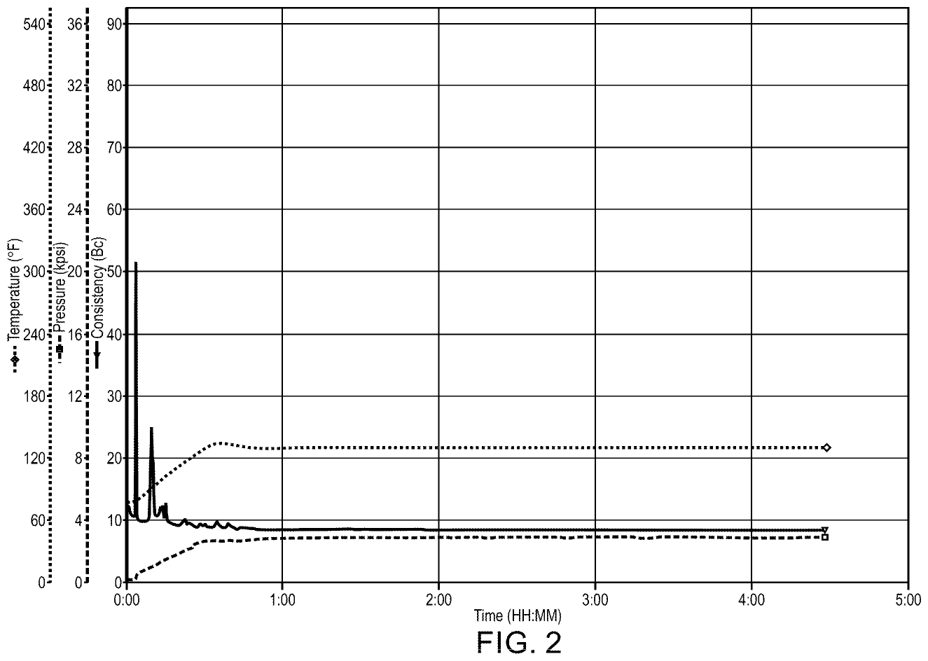

The conditioned slurry was then poured into an API standard high pressure and temperature (HP/HT) consistometer slurry cup to evaluate the thickening time. The tests determined the length of time the slurry remained in a pumpable fluid state under simulated wellbore conditions, that is, to simulate pumping under high temperature and high pressure conditions. API thickening time was measured in Bearden Consistency Units (B_{c}), on a scale of 0-100 B_{c}. A freshly prepared slurry started at less than 30 B_{c}, and 100 B_{c} indicated the end of the test. FIG. 2 shows a typical thickening time test result—the slurry remained in liquid state, while the consistency profile was a horizontal straight line. Then, as the slurry set, the consistency increased until it reached 100 B_{c}.

### Curing at Down-Hole Conditions

The HP/HT curing chamber was used for curing slurries at elevated temperatures and at pressures to simulate wellbore conditions. The slurries were poured into standard API compressive strength 2-in cubic molds. After that, the curing chamber was filled with water to expel any present gas. A temperature controller regulated the sample temperature. Pressures and temperatures were maintained until shortly before the end of the curing. The conditions were 229 ° F. curing temperature, and 3,000 psi confining pressure. Then parameters were reduced to ambient conditions, and the test specimens were removed from the curing chamber.

### Compressive Strength Testing

After the cement specimens had cured, the compressive strength was measured. The samples were subjected to known compressive loads via the hydraulic press equipment employed in this study. According to API requirements for oil well cement testing, this system was designed to measure the compressive strength of a cured sample. The cubes of set slurry were removed from the molds and placed in the hydraulic press, where each cube was subjected to increasing uniaxial loads until failure. Then, by dividing the load at which failure occurred by the sample's cross-sectional area, the compressive strength was determined.

### Results

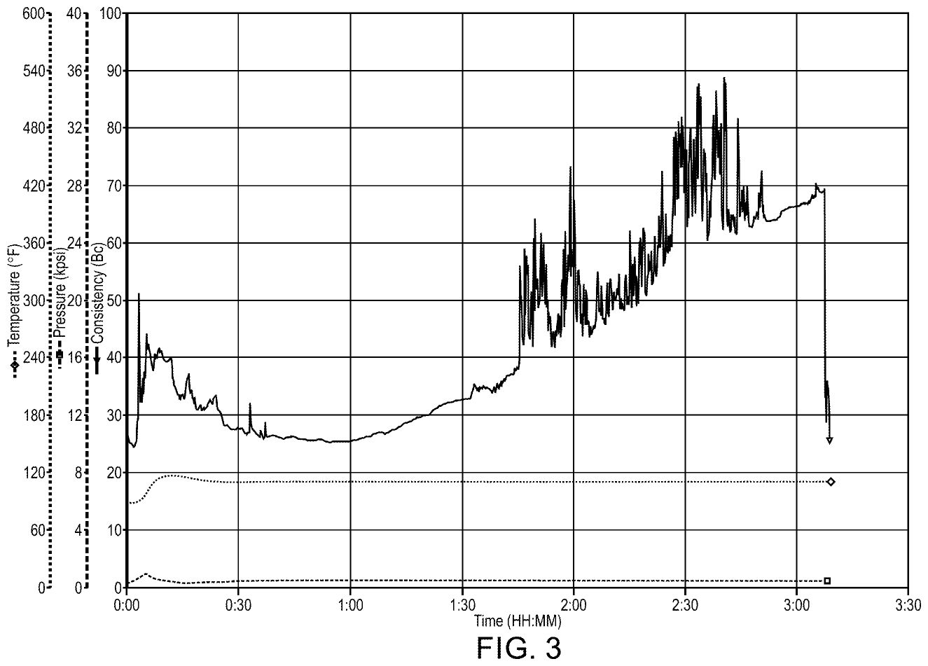

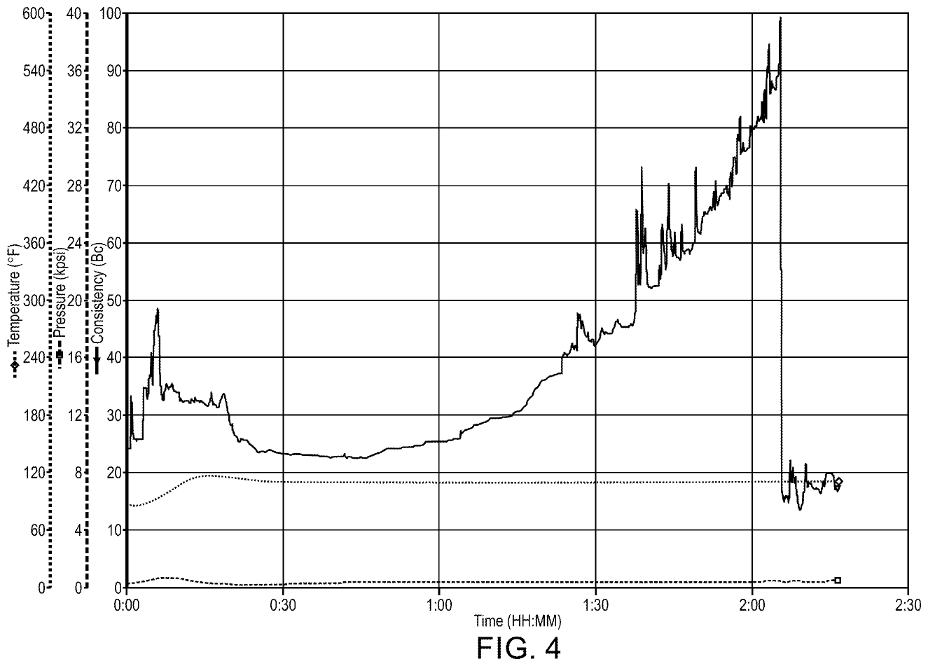

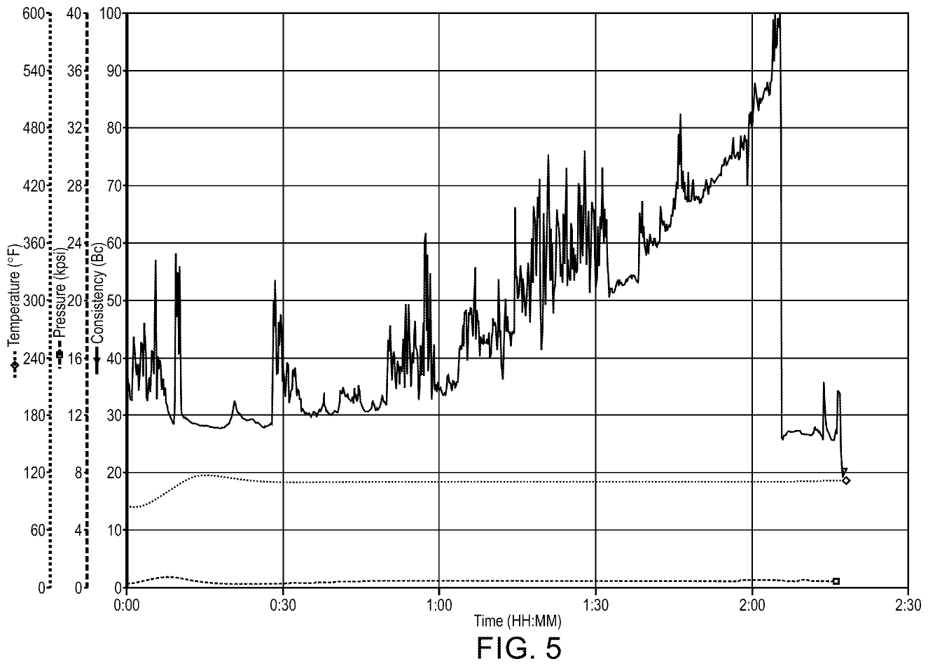

The thickening time results for Slurry 1 are shown in FIG. 3. Slurry 1 reached 70 B_{c} about 2 hours after mixing. The thickening time results for Slurry 2, including an increased concentration of curing agent (TEPA), are shown in FIG. 4. Slurry 2 reached 70 B_{c} more quickly than Slurry 1, about 1 hour and 40 minutes after mixing. The thickening time results for Slurry 3, including a further increased concentration of curing agent (TEPA), are shown in FIG. 5. Slurry 3 reached 70 B_{c} more quickly than Slurries 1 or 2, about 1 hour and 20 minutes after mixing. The results demonstrate that gelation time decreased with increasing concentration of curing agent.

Rheological data for Slurries 1-3 is shown in Table 4, below.

TABLE 4
Rheological Data

| Property | Result |
|---|---|
| Drilling Fluid Density (pcf) | 87 |
| Resin Slurry Density (pcf) | 100 |
| Total Depth (ft) | 500 |
| Bottom Hole Static Temperature (° F.) | 110 |
| Bottom Hole Circulating Temperature (° F.) | 110 |
| Time to Reach Bottom (min) | 33 |
| Bottom hole Pressure (psi) | 500 |
| Unconfined Compressive Strength (UCS) (psi) | 421^{†} |

^{†}Measured only for Slurry 1

### Embodiments

Certain embodiments of the present disclosure are provided in the following list:

Embodiment 1. A slurry, comprising:

about 20 wt % to about 60 wt % of an epoxy resin;

about 0.01 wt % to about 5 wt % of a curing agent;

about 20 wt % to about 60 wt % silica sand; and

about 1 wt % to about 40 wt % silica flour.

Embodiment 2. The slurry of embodiment 1, comprising less than 5 wt % of cement.

Embodiment 3. The slurry of embodiment 1, wherein the slurry is substantially free from cement.

Embodiment 4. The slurry of any one of embodiments 1-3, wherein the epoxy resin comprises a bisphenol-A-based epoxy resin, a bisphenol-F-based epoxy resin, and aliphatic epoxy resin, or any combination thereof.

Embodiment 5. The slurry of any one of embodiments 1-4, wherein the epoxy resin comprises a bisphenol-A-based epoxy resin and an aliphatic glycidyl ether.

Embodiment 6. The slurry of any one of embodiments 1-4, wherein the epoxy resin comprises a bisphenol-A-epichlorohydrin epoxy resin and a C₁₂-C₁₄ alkyl glycidyl ether.

Embodiment 7. The slurry of embodiment 6, wherein a weight ratio of a total amount of bisphenol-A-epichlorohydrin epoxy resin and C₁₂-C₁₄ alkyl glycidyl ether present in the slurry is about 6:1 to about 1:1.

Embodiment 8. The slurry of any one of embodiments 1-7, comprising about 30 wt % to about 55 wt % of the epoxy resin.

Embodiment 9. The slurry of any one of embodiments 1-8, wherein the curing agent comprises trimethyl hexamethylene diamine (TMD), diethylenetriamine (DETA), triethylenetetramine (TETA), meta-xylenediamine (MXDA), aminoethylpiperazine (AEP), tetraethylenepentamine (TEPA), polyetheramine, isophoronediamine (IPDA), beta-hydroxyalkyl amide (HAA), or any combination thereof.

Embodiment 10. The slurry of embodiment 9, wherein the curing agent comprises TEPA.

Embodiment 11. The slurry of any one of embodiments 1-10, comprising about 0.5 wt % to about 2.5 wt % of the curing agent.

Embodiment 12. The slurry of any one of embodiments 1-11, wherein an average particle size of the silica sand is about 75 μm to about 250 μm.

Embodiment 13. The slurry of any one of embodiments 1-11, wherein an average particle size of the silica sand is about 100 μm to about 200 μm.

Embodiment 14. The slurry of any one of embodiments 1-13, comprising about 30 wt % to about 50 wt % of silica sand.

Embodiment 15. The slurry of any one of embodiments 1-14, wherein an average particle size of the silica flour is about 5 μm to about 75 μm.

Embodiment 16. The slurry of any one of embodiments 1-14, wherein an average particle size of the silica flour is about 15 μm to about 60 μm.

Embodiment 17. The slurry of any one of embodiments 1-16, comprising about 7 wt % to about 30 wt % of silica flour.

Embodiment 18. The slurry of any one of embodiments 1-17, wherein a weight ratio of silica sand to silica flour present in the slurry is about 3:1 to about 1:1.

Embodiment 19. The slurry of any one of embodiments 1-18, wherein silica sand and silica flour are present in a combined amount of at least about 40 wt % of the slurry.

Embodiment 20. A method of sealing a wellbore, comprising

injecting the slurry of any one of embodiments 1-19 into an annulus of the wellbore; and

curing the slurry to form a cured composition, thereby sealing the annulus.

Embodiment 21. The method of embodiment 20, wherein the annulus comprises a casing-casing annulus of the wellbore.

Other implementations are also within the scope of the following claims.

1. A slurry, comprising:
about 20 wt % to about 60 wt % of an epoxy resin;
about 0.01 wt % to about 5 wt % of a curing agent;
about 20 wt % to about 60 wt % silica sand; and
about 1 wt % to about 40 wt % silica flour.

2. The slurry of claim 1, comprising less than 5 wt % of cement.

3. The slurry of claim 1, wherein the slurry is substantially free from cement.

4. The slurry of claim 1, wherein the epoxy resin comprises a bisphenol-A-based epoxy resin, a bisphenol-F-based epoxy resin, and aliphatic epoxy resin, or any combination thereof.

5. The slurry of claim 1, wherein the epoxy resin comprises a bisphenol-A-based epoxy resin and an aliphatic glycidyl ether.

6. The slurry of claim 1, wherein the epoxy resin comprises a bisphenol-A-epichlorohydrin epoxy resin and a C₁₂-C₁₄ alkyl glycidyl ether.

7. The slurry of claim 6, wherein a weight ratio of a total amount of bisphenol-A-epichlorohydrin epoxy resin and C₁₂-C₁₄ alkyl glycidyl ether present in the slurry is about 6:1 to about 1:1.

8. The slurry of claim 1, comprising about 30 wt % to about 55 wt % of the epoxy resin.

9. The slurry of claim 1, wherein the curing agent comprises trimethyl hexamethylene diamine (TMD), diethylenetriamine (DETA), triethylenetetramine (TETA), meta-xylenediamine (MXDA), aminoethylpiperazine (AEP), tetraethylenepentamine (TEPA), polyetheramine, isophoronediamine (IPDA), beta-hydroxyalkyl amide (HAA), or any combination thereof.

10. The slurry of claim 9, wherein the curing agent comprises TEPA.

11. The slurry of claim 1, comprising about 0.5 wt % to about 2.5 wt % of the curing agent.

12. The slurry of claim 1, wherein an average particle size of the silica sand is about 75 μm to about 250 μm.

13. The slurry of claim 1, wherein an average particle size of the silica sand is about 100 μm to about 200 μm.

14. The slurry of claim 1, comprising about 30 wt % to about 50 wt % of silica sand.

15. The slurry of claim 1, wherein an average particle size of the silica flour is about 5 μm to about 75 μm.

16. The slurry of claim 1, wherein an average particle size of the silica flour is about 15 μm to about 60 μm.

17. The slurry of claim 1, comprising about 7 wt % to about 30 wt % of silica flour.

18. The slurry of claim 1, wherein a weight ratio of silica sand to silica flour present in the slurry is about 3:1 to about 1:1.

19. The slurry of claim 1, wherein silica sand and silica flour are present in a combined amount of at least about 40 wt % of the slurry.

20. A method of sealing a wellbore, comprising
injecting the slurry of claim 1 into an annulus of the wellbore; and
curing the slurry to form a cured composition, thereby sealing the annulus.

21. The method of claim 20, wherein the annulus comprises a casing-casing annulus of the wellbore.
